(19) United States
(12) Patent Application Publication
(10) Pub. No.: US 2022/0049865 A1
(43) Pub. Date: Feb. 17, 2022

(54) Ventilation airflow in confined spaces to inhibit the transmission of disease

(71) Applicant: Robert Edward Breidenthal, JR., Seattle, WA (US)

(72) Inventor: Robert Edward Breidenthal, JR., Seattle, WA (US)

(21) Appl. No.: 17/399,014

(22) Filed: Aug. 10, 2021

Related U.S. Application Data
(63) Continuation of application No. 63/064,625, filed on Aug. 12, 2020.

(51) Int. Cl. F24F 7/10

(52) U.S. Cl. CPC F24F 7/10

(57) ABSTRACT

The present invention relates to a reduction in the propagation rate of airborne pathogens by an improved airflow ventilation pattern in confined spaces, such as in buildings or in vehicles. Since human beings are normally horizontally disposed with respect to each other, the optimum airflow pattern minimizes the horizontal component of the airflow velocity field. This invention addresses the fluid-mechanical requirements to achieve this goal.

### TECHNICAL FIELD

The present invention relates to the reduction in transmission of contaminants in confined spaces. Contaminants include virus particles, bacteria particles, dirt, and dust. Confined spaces include buildings, hospital rooms, aircraft cabins, buses, automobiles, elevators, subways, and rail cars. The present invention relates to minimizing the transport of contaminants by consideration of the ventilation airflow pattern.

### BACKGROUND ART

The current COVID-19 pandemic reveals a critical need to reduce the rate of transmission of the virus. After the present pandemic is over, other pathogens are likely to plague humanity. Even ordinary influenza routinely kills many people.

A major factor in the transmission of many pathogens is the airborne transport of very small particles or droplets generated from breathing, speaking, singing, and coughing by individuals with the virus. The dynamics of particles in air is determined by the Stokes number of two-phase flow (Michaelides et al. 2016).

Sufficiently small particles have a settling velocity in still air that is so small that they are carried along by even slight breezes (Stokes number much less than unity). For example, an isolated sphere of 2 micron diameter and density of liquid water has a settling speed in still air at 1g of about 0.015 cm/s. The settling speed for a particle in Stokes flow (where the Reynolds number less than about one) is proportional to the square of the particle diameter. So a 20 micron diameter particle has a settling speed of about 1.5 cm/s. If a number of particles are closely-spaced in a dense cloud in a non-dilute mixture, the settling speed can be much lower, because their boundary layers overlap.

The transmission of the COVID-19 virus seems to require at least a certain threshold exposure. This implies that little transmission occurs outdoors, as the particles would only be found in the turbulent wake immediately downstream from an infected person. For people spending long periods of time indoors, however, the air motions there seem to have a large effect on the rate of transmission. This raises the question of the optimum airflow within a confined space to reduce the transmission rate of viral and bacteriological diseases.

In modern life, most humans spend the majority of their time in confined spaces, such as in aircraft, automobiles, buses, trains, buildings, and elevators. Humans are typically horizontally disposed with respect to each other. The main purpose of this invention is to improve the airflow pattern inside of confined spaces in order to reduce the transmission rate of diseases such as COVID-19.

An ancillary benefit is increased efficiency and reduced operating costs of heating, ventilation, and air conditioning (HVAC) systems of buildings and vehicles. For example, the range of electric buses is severely degraded in cold and hot weather, in part due to the energy expended on heating and air conditioning.

In order to reduce the disease transmission rate, one strategy is to lower the number density of contaminating particles by dilution. Even if the inlet flow generates large recirculation flows, or “bubbles”, within the volume, the number density of offending particles can be reduced by brute force, sometimes represented by the assertion: “The solution to pollution is dilution.” One difficulty with this strategy is that the heating, cooling, de-humidification, and filtering requirements may be excessive. Another difficulty is that the dilution is not uniform. An unfortunate person may happen to be located directly downwind of an infected person, continually immersed in the near field of their contaminated wake. If there has not been enough distance for appreciable mixing and dilution, then the downstream person can not benefit from dilution. In the limit of instantaneous and perfect mixing, everyone within the volume would be subjected to the same exposure of the pathogen.

A more elegant solution is to uniformly displace the air within the volume without any recirculating or separation bubbles. In this displacement strategy, mixing is neither required nor desirable. Instead, a smooth, uniform, laminar flow attempts to efficiently displace every fluid parcel throughout the volume. If achieved, this would prevent anyone from being in the wake of an infected individual, while providing the most efficient indoor ventilation at minimum HVAC operating cost.

Human beings are typically horizontally disposed with respect to each other. If the dominant transmission mechanism is airborne transport of small particles, a critical factor is the horizontal component of the air flow. A purely vertical airflow would minimize the horizontal velocity component and the rate of transmission of disease.

Whitfield (U.S. Pat. No. 3,273,323) invented a laminar flow air hood apparatus to inhibit contamination of small, unwanted particles of dirt, impurities, and contaminants. This development is important in the manufacture of integrated circuits and other processes requiring ultra-clean environments. A number of studies have examined some aspect of displacement ventilation in buildings, for example Becker (2001), Lee et al. (2009), Chang et al. (2013), Raftery et al. (2015), and Mateus & da Graca (2017). Recently Bhagat & Linden (2020) and Bhagat et al. (2020) have explicitly addressed mitigating the transport of COVID-19 virus with improved building ventilation. Becker (2001) illustrates idealized displacement ventilation in his FIG. 3 on page 27.3.

In many respects, a uniform, downward flow of clean air would seem to be the optimal strategy to achieve a clean environment. Its presumed uniform, laminar flow minimizes turbulent eddies and recirculating air within the room. Furthermore, solid and liquid particles typically have a density greater than that of air, so that they would naturally tend to settle down to the floor, just in the direction helpfully provided by the ambient flow.

For uninhabited volumes like automated integrated circuit manufacturing cleanrooms, this configuration may be ideal. Counterintuitively, however, it may not be optimum if people are present.

A living human has a resting metabolic rate of the order of 100 watts. This waste heat is largely transferred to the surrounding air through a thermal boundary layer. In a 1g environment, the warm air is positively buoyant and tends to rise in a turbulent plume. In a conventional cleanroom with slowly descending air, the human plume may initially rise against the ambient flow. The speed of the plume decreases with altitude as it entrains ambient air. Eventually the ascent of the plume is arrested by the counterflow of ambient air, and the plume begins to descend as well. The trajectory of such plume resembles a fountain, as illustrated in FIG. 2.

The maximum achieved height z* of a plume in a descending environment can be estimated by equating the ascent speed of a canonical turbulent plume in a quiescent environment with the descent speed of the ambient fluid. Dimensional analysis yields the result that the ascent height is approximately equal to the buoyancy flux B divided by the cube of the speed V of the descending ambient air. The buoyancy flux is the acceleration of gravity times the heat release rate divided by the product of the ambient air density, the specific heat at constant pressure, and the absolute temperature of the ambient air. Further consideration of the dynamics of confined flows with compact buoyancy and momentum sources may be found in Linden and Cooper 1996; Linden 1999; Liu and Linden 2002; Liu and Linden 2005; Liu and Linden 2006; and Bolster and Linden 2007.

The integrated buoyancy flux B of a round, self-similar, turbulent plume in a quiescent environment has dimensions of (length)⁴/(time)³. Since this is the conserved quantity, the characteristic vertical speed w of the plume is proportional to B^{1/3} z^{-1/3} where z is the height from the virtual origin. Therefore the volume flow rate of the plume is proportional to B¹⁻³ z^{5/3}.

For example, if the ambient air is descending at V=10 cm/s, z* is estimated to be about 3 m for a 100 W person, assuming a self-similar, turbulent plume. In a room with a ceiling lower than this height above the person, the plume will impinge on the ceiling, possibly mixing with and then descending with the incoming ventilation air. If the ambient flow is descending sufficiently fast, z* may be so small that the plume never reaches the ceiling. Instead, the plume will turn around and descend toward the floor as it continues to grow. Either way, air within the plume will descend toward the floor and toward other people in the room. There is considerable horizontal transport.

Now consider an empty room with an ascending ventilation air flow, shown in FIG. 1. The plume above a living human or other source of thermal energy in such an environment is illustrated in FIG. 3. With upward, co-flowing air, the plume tends to continue upward, rather than descending. If the ambient upward velocity is sufficient, there is almost no horizontal transport. Plume air from one person would not tend to reach another person in the room.

An optimally uniform flow coming out of the floor is achieved if the floor is porous with the solidity of no more than 42%, according to the work of Loehrke & Nagib (1972, 1976) and Nagib et al. (1975) on turbulence manipulators. If this condition is not satisfied, then discrete jets are formed, which combine together to prevent a uniform flow. Note that multiple porous plates, screens, and honeycomb may be combined in the floor and/or ceiling to achieve a desired flow quality or pressure drop, as studied by Nagib et al. (1975). If several turbulence manipulators are combined in series, it is important that the most downstream one have a solidity of no more than 42% to prevent the undesirable formation of jets.

If there is a plenum or manifold underneath the floor supplying the flow up through it, the flow may not be uniform through the porous floor if the pressure in the manifold is not uniform. This nonuniform pressure occurs when the manifold cross section is too small to achieve a sufficiently low velocity within it. A relatively thin manifold may be required in many applications where vertical space is limited, especially in retrofit situations. As air progressively leaves the manifold through the porous floor, the velocity within the manifold declines with downstream distance due to isentropic deceleration, so that the static pressure increases, resulting in an undesirable variation in the flow speed through the porous floor. This undesirable effect can be eliminated if the manifold cross section is tapered, such that the velocity and pressure within the manifold are uniform everywhere, as illustrated in FIG. 5. If there are multiple inlets into the manifold, multiple taper profiles would be arranged accordingly. Another embodiment is to progressively vary the local pressure-drop coefficient of the porous floor in such a way as to compensate for the non-uniform manifold pressure in order to achieve a uniform upward velocity within the room. The pressure-drop coefficient is defined as the pressure difference across the porous floor divided by the dynamic pressure of the flow immediately above it. The same considerations apply to the manifold in the ceiling and apply whether the ventilation airflow is vertically upward or downward.

The plume will entrain ambient fluid, thereby increasing its volume flow rate as it rises. The entrainment rate may be estimated to within a dimensionless constant by assuming that the Richardson number of a self-similar plume is a constant of order unity, and that the rotation period of the large-scale eddies is approximately equal to their age. In a confined space, the plume will eventually impinge on the ceiling, as shown in FIG. 4. If that ceiling is porous and the ambient flow is upward, the volume flow rate of the plume there will pass through the ceiling over a planform area approximately equal to that volume flow rate divided by the average upward velocity through the porous ceiling. On the other hand, if the upward velocity of the ambient flow is insufficient, the porous ceiling can not accept all of the plume air. The rejected fraction of the plume air will descend after impingement and move horizontally into the plume in order to help satisfy the entrainment appetite of the plume. Such horizontal air motions are precisely the feature of conventional ventilation patterns that has resulted in many fatalities and illnesses.

The minimum upward velocity Vₘᵢₙ required to prevent plume air from one person from reaching anyone else in the room is the plume volume flow rate at impingement divided by the planform area of the entire planform area of the porous ceiling. In turn, the plume volume flow rate is determined by the metabolic rate of the source generating the plume and the vertical distance above her to the ceiling. This can be estimated from the growth of a self-similar, turbulent plume as indicated above, or it can be measured directly by experiment. If there are multiple sources of buoyancy, for example from multiple people, heat-generating equipment, or warm walls and windows, then the ceiling volume flow rate must exceed the entire plume flow at the ceiling.

Note that the flow patterns described here correspond to quasi-stationary occupants. If a person is moving sufficiently rapidly, their turbulent wake will transport air horizontally irrespective of the ventilation airflow pattern. The probability of transmission of a pathogen typically depends on the magnitude of the exposure, i.e. the number of pathogen particles inhaled. If the fraction of the time that rapid human motion overpowers the ventilation system is sufficiently small, then a vertical ventilation airflow will dramatically reduce the magnitude of the exposure, possibly below the threshold of infection.

A source of thermal energy, like a living person or a running computer, must be relatively compact in order to form a plume within a room. For example, thermal energy from surfaces illuminated by diffuse lighting tends not contribute to plume flow, since the resulting buoyant air is so widely distributed that can not readily evolve into a plume in the restricted space of the room. However, a relatively warm wall or window tends to form a buoyant wall plume. In order to extract all the volume flow rate of all concentrated buoyancy sources, the velocity through the porous ceiling must be sufficient to accommodate the volume flow rate of all the plumes.

For upward ventilation at a single, constant velocity, particles with precisely that same settling velocity will tend to remain suspended for the longest time. If all particles have about the same density and shape, then that corresponds to a particular particle size. One strategy to minimize the suspension time is to vary the upward ventilation velocity with time, so that no single particle size remains suspended for long. The variation can be relatively slow. Embodiments include a sinusoidal or square-wave modulation in the vertical ventilation velocity by varying the ventilation fan speed or a modulated valve.

Porous floors and ceilings that span the entire volume are optimal for the achievement of uniform flow within the volume. There can be no shear-induced entrainment if there is no shear. The incremental cost to incorporate the present invention into the design of new construction is minimal, with the attractive prospect of the lowest possible HVAC operating costs in the future.

However, in the retrofitting of existing buildings and vehicles, there may be practical constraints that preclude this ideal geometry, due to obstructions or limited space. Instead of a porous floor that spans the entire horizontal extent of the volume, consider a number of closely spaced floor vents. Each discrete vent will generate a discrete, collimated, turbulent jet with an associated upward momentum. Jets are strong mixers, with a large entrainment appetite. The turbulent vortices at the edge of each jet draw ambient air into the jet, which is then rapidly accelerated away. The volume flow rate of an incompressible jet from a round nozzle into quiescent fluid increases by about one-third of the initial volume flow rate as the downstream station increases by one nozzle diameter. The volume flow rates of plumes can be estimated from the published literature (Turner 1973) or measured with standard laboratory diagnostics, such as hot wires. Corrections for co- and counter-flow to the entrainment rate of shear flows such as jets and plumes can be estimated following Brown and Roshko (1974).

If the jets are too strong compared to the ventilation flow, the voracious entrainment appetite of the jets will be satisfied by recirculating flows between the jets, necessarily resulting in reversed flow and the horizontal transport of any suspended particles, as indicated in FIG. 6. The horizontal transport distance from jet entrainment is about half of the separation distance between identical inlet vents. In general, the more closely spaced the vents, the weaker the jets with respect to the ventilation flow and the smaller the distance of undesirable horizontal transport.

In order to inhibit the transport of pathogens to an occupant of the confined space, the separation between the inlet floor vents should be much less than the distance from that occupant to the nearest infected person. The probability of at least one person in an interacting group being infected increases rapidly with the size of the group, according to probability theory related to the famous and counter-intuitive “birthday paradox”. In a crowded enclosure with people disposed in the horizontal directions, the potential transmission rate therefore increases rapidly with the extent of the horizontal air motions and hence the separation between inlet vents.

For the absolute minimum probability of airborne transmission, the number of people breathing the same contaminated air should be as small as possible. If the characteristic dimensions of people and of their horizontal separation are both about a meter or two, this implies that the ventilation inlets or diffusers should be much less than a meter apart for optimum effectiveness. Loudermilk (1999), Bauman and Webster (2001), Bauman et al. (2006), Webster et al. (2007) and Webster et al. (2012) describe conventional underfloor air distribution systems, with much more widely spaced inlet diffusers, necessarily resulting in relatively large horizontal transport of particles between occupants. In a crowded enclosure, conventional ventilation systems ensure that many people breath the same air, dramatically increasing the chances of disease transmission.

In contrast to the collimated, turbulent jets from an inlet diffuser, the flow into the exhaust vent or vents is essentially potential sink flow and is therefore relatively smooth and uncollimated. Even with potential flow, however, the extent of the horizontal transport will again be approximately equal to the separation distance between discrete exhaust vents. If the ideal configuration is not feasible in a retrofit application, due to constraints from existing structures, some of the benefits of the present invention may still be achievable.

Retrofits may include the addition of a relatively thin floor plenum installed on top of a conventional, nonporous floor. This necessarily reduces the remaining height available in the room or confined space. However, with the tapered cross section of the plenum or a variable pressure-drop coefficient across the perforations, a uniform upward flow can be achieved with a relatively thin plenum, resulting in only a small reduction in height available. A retrofit plenum may also be added to the ceiling. Applicable to both ascending and descending ventilation flows, this improvement may offer the lowest cost upgrade to existing buildings and vehicles.

### DESCRIPTION OF THE DRAWINGS

FIG. 1 illustrates one configuration of a room with upward-flowing ventilation. Air 1 enters via a duct 2 into a plenum 3. The air flows through a porous floor 4 into an enclosure or room 5 with a vertical speed 6. Air 10 leaves the room through a porous ceiling 7 into a plenum 8 and duct 9.

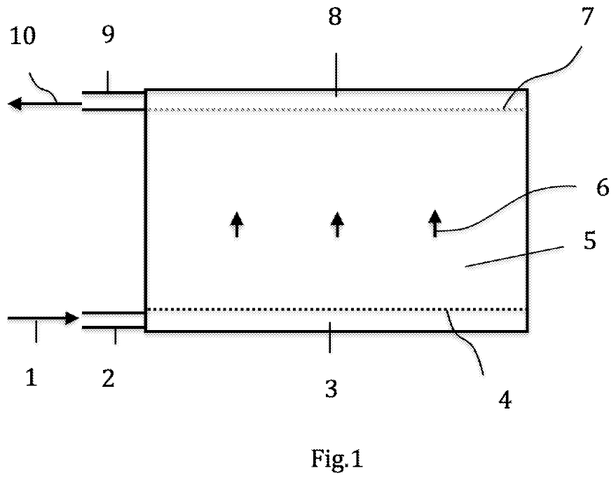

FIG. 2 indicates the behavior of plumes with descending ambient air 11. Just above a person 12, the initial plume flow 13 is upward, but the plumes eventually stop and reverse 14.

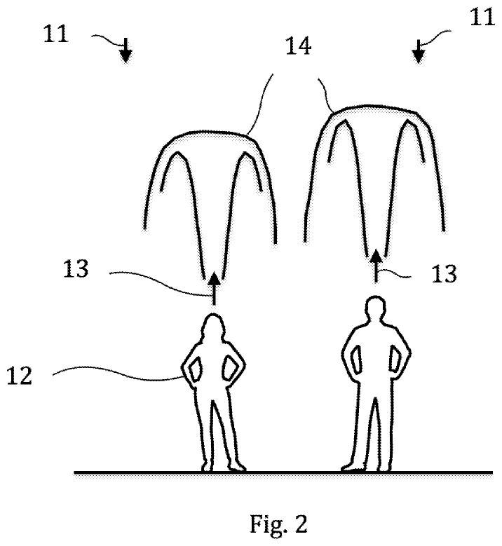

FIG. 3 describes the plume behavior in an environment with upward, co-flowing air 15. The plumes 16 tend to rise.

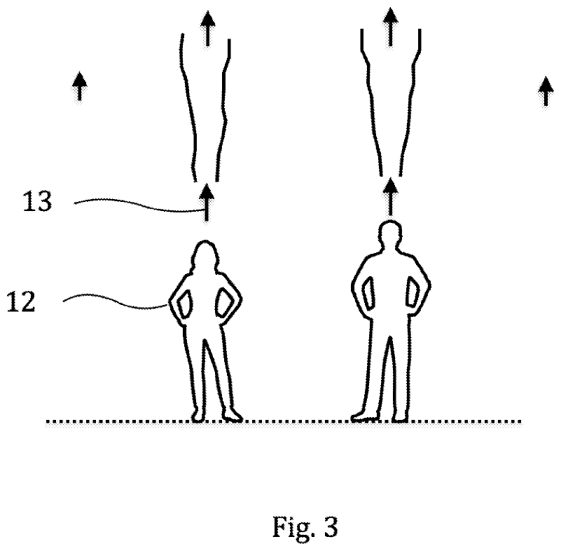

FIG. 4 illustrates the impingement 14 of a rising plume 16 on the porous ceiling 7. All of the plume air will enter the porous ceiling at sufficient upward ambient velocity 15.

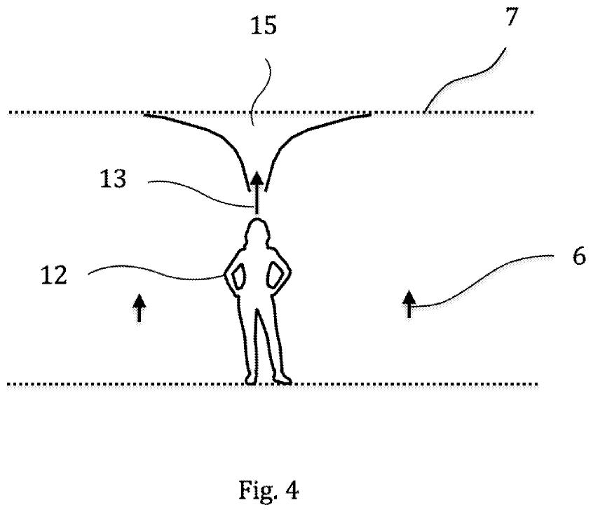

FIG. 5 shows one means of providing uniform velocity by achieving constant pressure in the floor and ceiling plenums or manifolds. The cross-sectional area of the floor manifold is progressively tapered 16 so as to maintain a constant horizontal speed and hence constant pressure within the floor manifold or plenum. The cross-sectional area 17 of the ceiling manifold is also tapered.

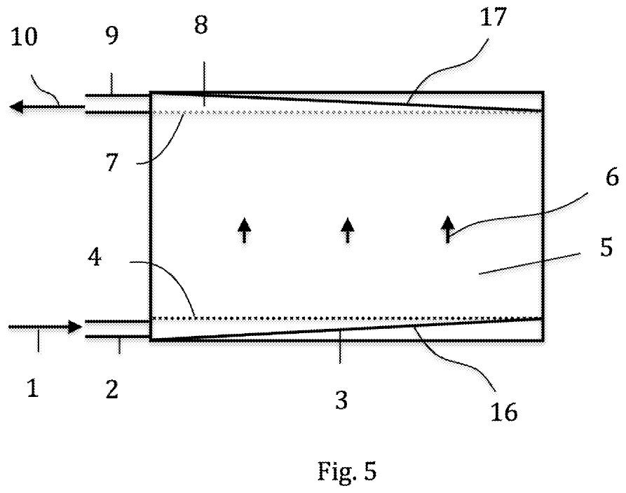

FIG. 6 illustrates the effect of multiple, discrete floor vents 18 on the air flow pattern in a room. Formed above each floor vent, the jets impinge on the ceiling and then descend. The descending air moves horizontally 19 as it is entrained into the turbulent jets.

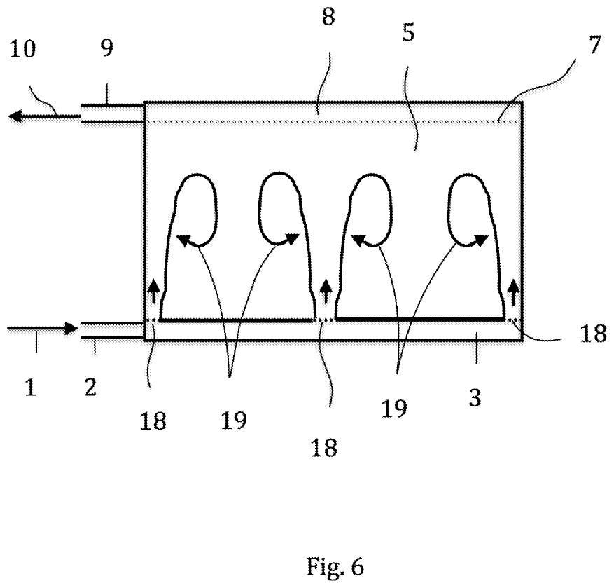

FIG. 7 depicts a vertical sectional view of an aircraft cabin 20, with a porous floor 21 and a porous ceiling 22. The ventilation air 6 flows upward.

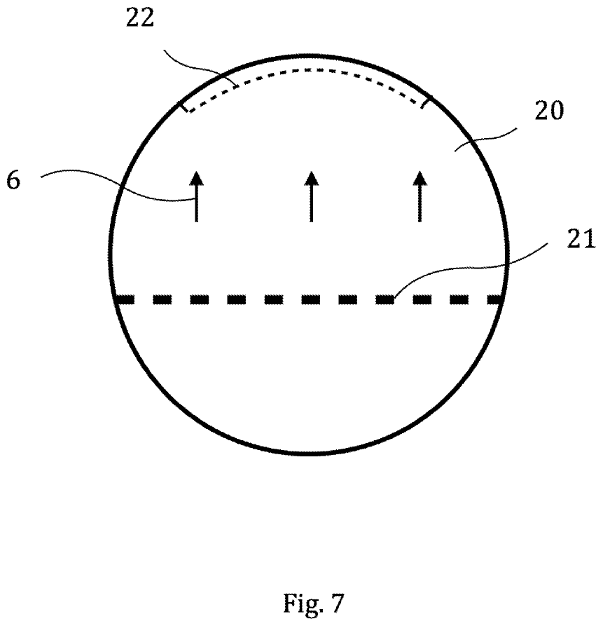

### REFERENCES

Bauman, F. and Webster, T., 2001 Outlook for underfloor air distribution, ASHRAE Journal 43 (6) 18-27 Bauman, F., Webster, T. and Jin, Hui, 2006 Design guidelines for underfloor air supply plenums, UC Berkeley: Center for the Built Environment.
Becker, A. 2001 “Ventilation and infiltration,” Ch. 27 in Handbook of Air Conditioning and Refrigeration, ed. Wang, S., McGraw-Hill
Bhagat, R. K. and Linden, P. F. 2020 Displacement ventilation: a viable ventilation strategy for makeshift hospitals and public buildings to contain Covid-19 and other airborne diseases, R. Soc. Open Sci., September 30; 7(9)
Bhagat, R. K., Davies Wykes, M. S., Dalziel, S. B. and Linden, P. F. 2020 Effects of ventilation on the indoor spread of COVID-19, J. Fluid Mech. 903, μl.
Bolster, D. T. and Linden, P. F. 2007 Contaminants in ventilated filling boxes J. Fluid Mech. (2007), vol. 591, pp. 97-116.
Brown, G. L. and Roshko, A. 1974 On density effects and large structure in turbulent mixing layers, Journal of Fluid Mechanics 97 775-816.
Chan, C. T., Leung, Y. T. and Liu, C. M. 2013 Integrated Performance of Chilled Ceiling and Under-Floor Plenum Air Supply Systems, ME 4904 Capstone Project Report, Department of Mechanical Engineering, The Hong Kong Polytechnic University
Lee, K. S., Zhang, T., Jiang, Z., and Chen, Q. 2009 “Comparison of airflow and contaminant distributions in rooms with traditional displacement ventilation and under-floor air distribution systems,” ASHRAE Transactions, 115(2).
Lin, Y. J. P. and Linden, P. F. 2002 Buoyancy-driven ventilation between two chambers J. Fluid Mech., vol. 463, pp. 293-312.
Lin, Y. J. P. and Linden, P. F. 2005 A model for an under floor air distribution system, Energy and Buildings 37 399-409.
Linden, P. F. 1999 The fluid mechanics of natural ventilation, Annual Review of Fluid Mechanics 31 201-238
Linden, P. F. and Cooper, P. 1996 Multiple sources of buoyancy in a naturally ventilated enclosure, Journal of Fluid Mechanics 311 177-192
Liu, Q. and Linden, P. F. 2006 The fluid dynamics of an underfloor air distribution system. Journal of Fluid Mechanics, 554, 323-341. doi:10.1017/S0022112006009414
Loehrko R. I. and Nagib, H. M. 1972 AGARD Rep. R-598
Loehrke. R. I. and Nagib H. M. 1976 Trans. A.S.M.E. I, J. Fluids Engr 98, 342-353
Loudermilk, K. J. 1999 Underfloor air distribution solutions for open office applications, ASHRAE Transactions 105 605-613
Mateus, N. and da Graca, G. C. 2017 Simulated and measured performance of displacement ventilation systems in large rooms, Building and Environment, 114, 470-482
Michaelides, E., Crowe, C. T., and Schwarzkopf, J. D. Multiphase Flow Handbook, 2nd Edition, Routledge, 2016
Nagib, H. M., Way, J. L. & Tan-atichat, J. 1975 Prog. Astro. Aero. 37, 503-520
Raftery, P., Bauman, F., Schiavon, S., and Epp, T. 2015 Laboratory testing of a displacement ventilation diffuser for underfloor air distribution systems, Energy and Buildings 108, 82-91
Turner, J. S. 1973 “Buoyancy Effects in Fluids”, Cambridge.
Webster, T., Lukaschek, W, Dickerhoff, D., and Bauman, F. 2007 Energy performance of underfloor air distribution (UFAD) systems Part II: Room air stratification full scale testing, CEC Contract 500-01-035.
Webster, T., Hoyt, T., Lee, E., Daly, A., Feng, D., Bauman, F., Schiavon S., Lee, K. H., Pasut, W., and Fisher, D. 2012 Influence of design and operating conditions on underfloor air distribution (UFAD) system performance, Conference: SimBuild2012 Fifth National Conference of IBPSA-USA

U.S. Pats.

| | | |
|---|---|---|
| 3,273,323 | Sep. 1966 | Whitfield |
| 4,267,769 | May 1981 | Davis etal. |
| 4,838,150 | Jun. 1989 | Suzuki et al. |
| 10,842,451 | Nov. 2020 | Opheij et al. |
| 10,962,246 | Mar. 2021 | Bromley |

What is claimed is:

1. A ventilation system configured to provide an approximately uniform, upward air flow within an enclosed volume, the system comprising:
a plenum or manifold beneath the floor of the volume;
a porous floor to the volume;
one or more exhaust ports in or near the ceiling of the volume; and
a supply of clean air pressurized to provide a volume flow rate substantially equal to or greater than the total volume flow rate of plumes and jets impinging on the ceiling from all sources of buoyancy and upward momentum.

2. The system of claim 1, wherein the enclosed volume is a room in a building.

3. The system of claim 1, wherein the enclosed volume is a cabin of an aircraft.

4. The system of claim 1, wherein the enclosed volume is the interior of a car of a train or subway.

5. The system of claim 1, wherein the enclosed volume is the interior of a bus.

6. The system of claim 1, wherein the enclosed volume is the interior of an automobile.

7. The system of claim 1, wherein the enclosed volume is the interior of an elevator car in a building.

8. The system of claim 1, wherein the exhaust port is a porous surface.

9. The system of claim 1, wherein the porous floor has a solidity of less than 43%.

10. The system of claim 1, wherein the porous floor consists of multiple layers of porous surfaces, such that the uppermost surface has a solidity less than 43%.

11. The system of claim 1 wherein the plenum or manifold has a cross section perpendicular to the flow within it that progressively decreases in the downstream direction from the plenum or manifold inlet so as to maintain an approximately constant pressure throughout the plenum or manifold.

12. The system of claim 1, wherein the porous floor has a local pressure-drop coefficient that progressively increases with distance from the plenum or manifold inlet so as to maintain an approximately constant flow speed through the porous floor.

13. The system of claim 1, wherein the vertical velocity of the ventilation airflow is varied with time.

14. A ventilation system configured to provide an approximately uniform, upward air flow within an enclosed volume, the system comprising:
a plenum or manifold beneath the floor of the volume;
multiple inlet ports distributed over the floor with a separation less than the design separation distance of the occupants in the volume;
one or more exhaust ports in or near the ceiling of the volume; and
a supply of clean air pressurized to provide a volume flow rate substantially equal to or greater than the total volume flow rate of plumes and jets impinging on the ceiling from all sources of buoyancy and upward momentum.

15. A ventilation system configured to provide an approximately uniform, downward air flow within an enclosed volume, the system comprising:
a plenum or manifold above the ceiling of the volume;
a ceiling consisting of a porous surface or a solid surface with discrete inlet vent nozzles;
one or more exhaust ports in or near the floor of the volume; and
a supply of clean air pressurized to provide a volume flow rate substantially equal to or greater than that of all plumes and jets impinging on the floor from all sources of buoyancy and downward momentum.

16. The system of claim 15, wherein the exhaust port is a porous floor.

17. The system of claim 15, wherein the porous ceiling has a solidity of less than 43%.
The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of then invention, the description taken with the drawings and/or examples making apparent to those skilled in the art how the several forms of the invention may be embodied in practice.
As used herein and unless otherwise indicated, the terms “a” and “an” are taken to mean “one”, “at least one” or “one or more”. Unless otherwise required by context, singular terms used herein shall include pluralities and plural terms shall include the singular.
Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.
The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.
All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.
Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.
